(19) United States
(12) Patent Application Publication
(10) Pub. No.: US 2025/0313337 A1
(43) Pub. Date: Oct. 9, 2025

(54) FULL-HEIGHT DIVIDER CURTAIN BETWEEN AIRCRAFT CABIN PASSENGER SUITES

(71) Applicant: AIRBUS ATLANTIC, ROCHEFORT (FR)

(72) Inventors: Silvère PLISSONEAU, PUILBOREAU (FR); Jean-Philippe MOQUETTE, ROCHEFORT (FR); Jean-Luc PINEAU, ROCHEFORT (FR); Mark COLLINS, COLLEX-BOSSY (CH); Alexandra COLLINS, COLLEX-BOSSY (CH); Jean-Baptiste BRUYERE, COLLEX-BOSSY (CH); Christophe CHARDIN, ROISSY CHARLES DE GAULLE (FR)

(21) Appl. No.: 19/171,654

(22) Filed: Apr. 7, 2025

(30) Foreign Application Priority Data
Apr. 8, 2024 (FR) 2403612

(51) Int. Cl. B64D 11/00

(52) U.S. Cl. CPC B64D 11/0023

(57) ABSTRACT

An aircraft cabin divider, for dividing two adjacent private passenger areas in first class, including a curtain hung by its top side from a top curtain rod, the divider having an open position and a closed position, and being full-height, thus covering a height up to the ceiling of the aircraft cabin wherein it is installed, and hooked by its bottom side to a bottom curtain rod opposite the top rod, the bottom rod being configured to allow the curtain to be detached from the bottom in the event of depressurization.

### CROSS-REFERENCE TO RELATED APPLICATIONS

This application is based on and claims priority under 35 U.S.C. § 119 to French Patent Application No. 2403612, filed on Apr. 8, 2024, in the French Intellectual Property Office, the disclosure of which is incorporated by reference herein in its entirety.

### BACKGROUND

### Field

The present disclosure belongs to the field of dividing assemblies and systems in aircraft cabins, in particular dividers between passenger suites, and relates more particularly to a full-height divider curtain, i.e. covering the entire height of the cabin, from floor to ceiling.

The present disclosure is directly, but not exclusively, applicable to the layout of first-class cabins airliners.

### Brief Description of Related Developments

The level of comfort required in higher airliner classes (business class and first class) must be able to offer passengers a high degree of privacy when traveling. For this purpose, airlines use dividers, which can be installed between classes or between different passenger areas. These cabin dividers have been known for a long time and exist in numerous designs to fulfill different functions.

In particular, passenger suite dividers are well known in aircraft. They are particularly used to divide first-class seats.

These dividers define a screen wall between adjacent seating areas, in order to divide them visually and thus ensure the privacy of the passengers occupying these seats.

Dividers are often formed from panels and therefore have rigid structures. They can be fixed or deployable according to the passenger's wishes. In the latter case, the dividers can comprise different manual or automatic deployment means, such as slide rails, pivot hinges, guide tracks (in the form of a pull-out section for example), etc.

Document US2020262562 describes, for example, different divider walls between two passenger seats including a first divider partition that is stowed in a console and is deployed along a guide track outside the console, toward first and second passenger seats to divide a first portion of the seating area.

These solutions typically have a low height, therefore only guaranteeing relative privacy when passengers are seated. Furthermore, because of their manufacturing materials, the same dividers made with a greater height would induce a considerable increase in their mass, which is not desirable in the field of air transport.

On the other hand, rigid full-height dividers could represent a major safety risk in the event of rapid cabin depressurization. Indeed, rapid decompression would pulverize the rigid divider, which would not allow air to pass, into several ejected pieces, capable of seriously injuring passengers. Therefore, this type of design has very little chance of passing the applicable qualification and certification tests.

However, there are dividers comprising a flexible curtain made of textile material, for example. The curtain makes it possible to effectively create a privacy barrier, without impeding movement between seating areas.

These divider curtains are installed between classes and not between passenger suites of the same class. Documents EP3365229 and US2014158310 describe such dividers.

In addition, when privacy is not a priority, these curtains are pulled to the side where they are folded back or concertinaed.

Some airlines invest time, money and effort in the visually appealing design of their cabins, thus hoping to attract more passengers. For example, they sometimes opt for a modern or minimalist design. However, curtains hanging on one side can have the opposite effect, giving the cabin an untidy and cluttered appearance, thus compromising the passenger experience.

It is therefore important that this type of divider has a harmonious appearance, both in the closed position and in the storage position on the side, for example by having regular and controlled waves.

### SUMMARY

The present disclosure aims to overcome all or part of the drawbacks of the prior art described hereinabove, by providing a solution for dividing between first-class passenger suites, which offers maximum privacy by covering the entire height of the cabin and which complies with safety requirements in the event of rapid decompression.

To this end, the present disclosure relates to an aircraft cabin divider, intended to divide two adjacent private passenger areas in the same class, including a curtain hung by its top side from a top curtain rod, said divider having an open position and a closed position. This divider is remarkable in that it is full-height, thus covering a height up to the ceiling of the aircraft cabin wherein it is installed, and in that it is hooked from its bottom side to a top curtain rod opposite the top curtain rod.

As it is full-height, this divider provides complete visual screening between adjacent passenger areas. This allows passengers to feel more secluded and protected from undesirable gazes, enhancing their sense of privacy during the flight.

The configuration with two curtain rods offers a kinematic advantage by allowing synchronized movement between the top and bottom of the curtain. This synchronization allows smooth and coordinated operation of the curtain, thus creating a harmonious feel in the cabin.

Furthermore, the use of a top curtain rod and a bottom curtain rod to support the curtain offers a visually appealing advantage by maintaining regular and controlled waves. This design thus contributes to a general atmosphere of comfort and sophistication.

It is important to note that the divider according the disclosure divides two private passenger areas in the same class, unlike prior art solutions which are exclusively used to divide between different classes.

The term class is used here as standardized by the International Air Transport Association (IATA).

According to one aspect, the curtain includes a first portion and a second portion that are separate, said portions being configured so that their movements are synchronized and joining at a central closing line when said divider is in the closed position.

This curtain design in two portions ensures that the curtain closes in a balanced and visually appealing manner, without leaving any space or gaps in the center.

According to one aspect, each top or bottom curtain rod includes a slide rail and sliders physically connecting the curtain to the slide rail, each slider including a sliding block on the rail and a hook for hooking the curtain.

Particularly advantageously, the sliders of each curtain rod are connected by a cord including stoppers placed at regular intervals, to maintain regular curtain waves.

According to one aspect of the disclosure, the divider includes a motorized drive system for automatically actuating the opening and closing movements of said divider, said system being coupled in a synchronized manner with both an upper portion and a lower portion of the curtain.

More particularly, at least one proximal lateral side of the curtain is coupled with the motorized drive system by means of two linking members: one in the upper portion and the other in the lower portion.

Thus, according to the curtain design in two portions, coupling with the motorized drive system takes place at four points: two upper points and two lower points near the vertices of the curtain.

According to a particularly advantageous aspect of the disclosure, the lower curtain rod is configured to allow the curtain to be detached from the bottom in the event of rapid decompression, when said divider is in the closed position in an aircraft cabin.

For example, the bottom curtain rod includes bottom sliders to attach the bottom side of the curtain, and each bottom slider includes a hook which is detached from the curtain beyond a maximum tensile load, to release the curtain in the event of rapid decompression of the cabin.

According to one aspect, the curtain is completely concealed in a compact storage space when the divider is in the open position.

The present disclosure also relates to an aircraft cabin comprising two adjacent private suites, in particular in first class, and including a divider as described, installed between said suites.

The fundamental concepts of the disclosure having been disclosed hereinabove in their most elementary form, other details and features will become more apparent upon reading the following description with reference to the appended drawings, giving, by way of non-limiting example, an aspect of a passenger suite divider, in accordance with the principles of the disclosure.

### BRIEF DESCRIPTION OF THE DRAWINGS

The figures are given purely by way of illustration for better understanding of the disclosure without limiting the scope thereof. The various elements may be shown schematically and are not necessarily to scale. In the set of figures, identical or equivalent elements bear the same numerical reference.

Thus, it is illustrated in:

FIG. 1: a perspective view of a divider between two passenger suites, according to one aspect of the disclosure;

FIG. 2a: a perspective view of the individual divider in the closed position;

FIG. 2b: a perspective view of the individual divider in the open position, with the curtain stored laterally in compact spaces;

FIG. 3a: a front view of the divider in the closed position;

FIG. 3b: a front view of the divider in the open position;

FIG. 4: the top and bottom groups of individual sliders, connected by cords;

FIG. 5: the top sliders with a detailed view of the top drive sliders;

FIG. 6: the basic structure of the top sliders;

FIG. 7: a top slider with its hook hooking an annular element of the curtain;

FIG. 8: the ring supporting the hook in a slider;

FIG. 9: a top slider positioned on the sliding rail, with a detailed view of the associated pair of stoppers;

FIG. 10: a partial view showing a top drive slider;

FIG. 11: another partial view showing the top drive slider according to a different angle;

FIG. 12: the bottom sliders with a detailed view of the bottom drive sliders;

FIG. 13: the basic structure of the bottom sliders;

FIG. 14: a partial view showing a bottom drive slider.

### DETAILED DESCRIPTION

It should be noted that certain technical elements well known to those skilled in the art are recalled herein to avoid any insufficiency or ambiguity in the understanding of the present disclosure.

In the aspect described hereinafter, reference is made to an aircraft cabin divider, primarily intended to be arranged between first-class passenger suites. This non-limiting example is given for a better understanding of the disclosure and does not exclude use of the divider in other classes, or in other suitable passenger transport vehicles.

In this document, the term “divider” means an assembly for separating space used inside an aircraft cabin or similar to separate different passenger areas, in particular private areas such as first-class passenger suites. Divider is the term commonly used in the field for this type of separator. The term “passenger suite” means a private area inside the cabin, generally in first class, comprising a chair convertible into a bed to comfortably accommodate a passenger, and which may include specific amenities such as storage, convenience elements and entertainment facilities for the passenger.

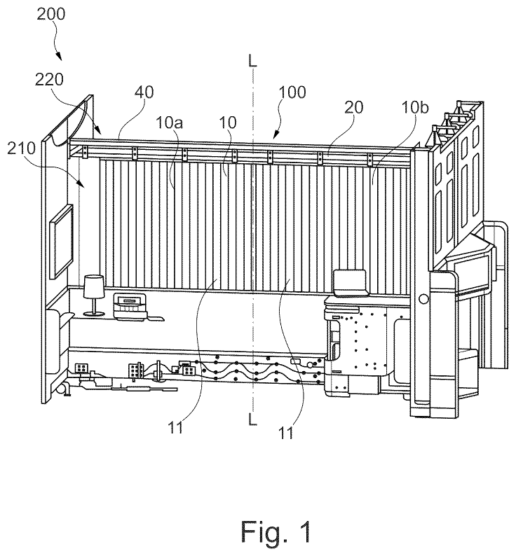

FIG. 1 shows an aircraft cabin divider 100, a portion of said cabin being designated by reference 200 in the figure, said divider being installed between two adjacent passenger suites 210 and 220. Such adjacent suites are usually located in a central portion of the first-class cabin.

For a better visibility of the divider 100 in its environment, and a better understanding of its arrangement, most of the elements of the passenger suite, including the chair, are not shown.

The divider 100 is full-height, i.e. it covers the entire usable height of the cabin. In other words, in a final configuration of the layout of the cabin 200, the divider 100 covers the entire height accessible to the passenger, up to the ceiling. Thus, in FIG. 1, the parts that appear to protrude from the divider 100 will be furnished with ceiling elements so that said divider occupies the entire height accessible to the passenger in the final cabin layout.

According to the exemplary aspect illustrated, the divider 100 covers the entire height available between a credenza dividing the two passenger suites and the cabin ceiling.

The divider 100 has for example a height of 3 m.

Thus, the divider 100 makes it possible to completely divide the areas of the adjacent suites 210 and 220.

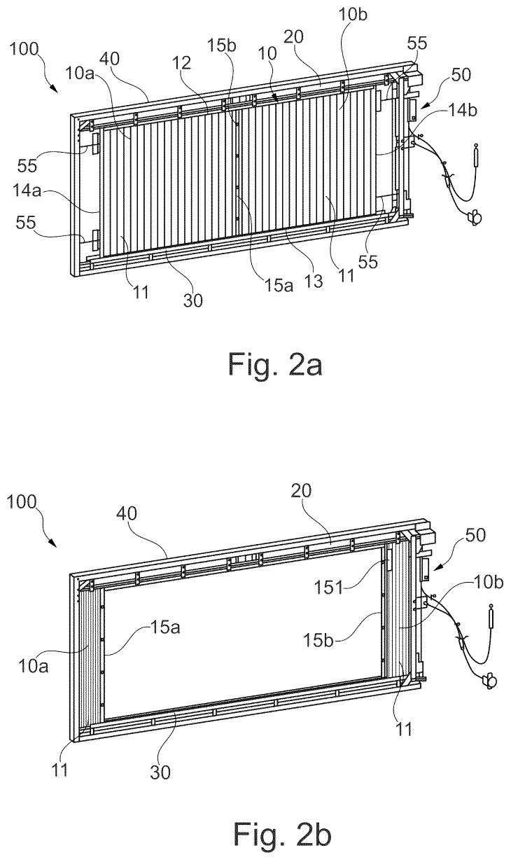

FIGS. 2a and 2b show the divider 100, alone, in a closed position and in an open position respectively.

The divider 100 includes a curtain 10, a top curtain rod 20 from which the curtain is hung by its top side, a bottom curtain rod 30 opposite the top curtain rod and to which the curtain is hooked by its bottom side, a frame 40 for attaching the divider by its upper portion to the cabin, and a motorized drive system 50 with a drive both via the top and via the bottom of the curtain 10.

The curtain 10, according to the exemplary aspect illustrated, consists of two separate portions: a first portion 10a and a second portion 10b. The two portions of the curtain 10 have opposite movements and join at a central closing line L when the divider 100 is in the closed position as shown in FIG. 1.

The curtain 10 has a top side 12 whereby it is hung from the top curtain rod 20, a bottom side 13 whereby it is hooked to the bottom curtain rod 30, a first proximal lateral side 14a and a second proximal lateral side 14b whereby the curtain 10 is coupled with the motorized drive system 50 at four points represented by the linking members 55.

As shown in FIG. 2a, the linking members 55 are distributed pairwise between the top and the bottom of the curtain 10, each of said members being attached in the vicinity of a vertex of the curtain 10 which has a rectangular shape.

The curtain 10 also has a first distal lateral side 15a and a second distal lateral side 15b, opposite the proximal lateral sides 14a and 14b, which join in the closed position at the junction line L.

The distal lateral sides 15a and 15b each include a lining providing stiffness to the structure of the curtain 10 especially during its closing movement, and can also include sets of magnets 151 to ensure easy closure that is held securely in place and thus limits light leakage at the closing line.

The curtain 10 defines waves 11 with regular spacing for a better visual appeal, both in the closed position and in the open position.

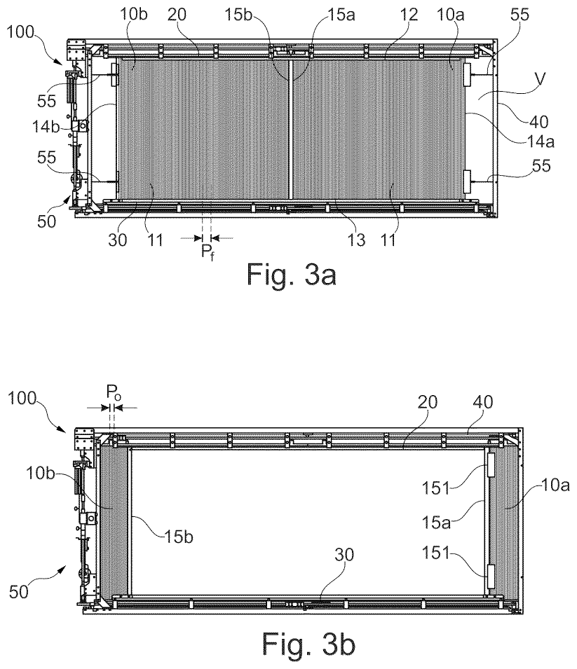

FIGS. 3a and 3b show, in a front view, respectively the closed position and the open position of the divider 100 and make it possible to visualize the regularity of the spacing of the waves 11 of the curtain 10.

Indeed, the curtain 10 defines waves 11 with regular spacing: Pf in the closed position and Pₒ in the open position of the divider 100.

According to one aspect, the curtain 10 is manufactured from an opaque textile material that is flexible enough to ensure regularity of the spacing of the waves 11 in the two positions of the divider 100.

The curtain 10 comprises, for example, in its internal structure, a specific membrane which makes it possible to fulfill the opacity function.

It should be noted that depending on its thickness, flexibility and weft orientation, the behavior of the fabric chosen for the curtain 10 may be different. A fabric with an advantageous combination of these parameters therefore had to be chosen to ensure both the total opacity to obscure any light passage between the two separate suites, regular waves for greater visual appeal, and a more compact size when the curtain 10 is stored on the sides in the open position.

For example, the curtain 10 may be made of a flexible fabric on which the waves produce “loft”-style folds.

With regard to space-saving storage, the curtain 10 folds away when it is moved back to the lateral sides of the frame 40, and causes a compression of the waves 11 that press against each other. It is therefore crucial that this compression is performed in an organized manner with substantially regular spacing in order to minimize the space required for storage.

FIG. 3b illustrates the reduced width of the space required for storing the curtain 10 when the divider 100 is fully open.

Furthermore, FIGS. 3a and 3b show that the space required for storing the curtain 10 corresponds to the void V, left between the deployed curtain 10 and the frame 40 seen in FIG. 3a. Hence, compartments or boxes (not shown) may be provided at these locations to receive the curtain 10 in stored position and conceal it when the divider 100 is open, thus improving the passenger experience.

The curtain 10 is hooked by its top 12 and bottom 13 sides to the upper 20 and lower 30 curtain rods.

The curtain rods 12 and 13 comprise sliding rails along which the curtain 10 moves, without excessive friction, via sliders 21 and 31 providing the physical connection between said curtain and said curtain rods.

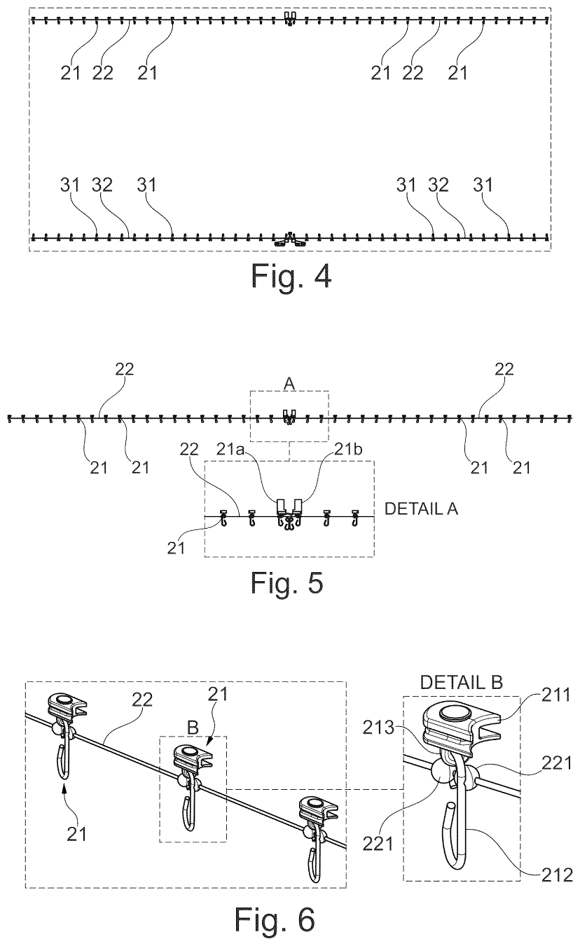

FIG. 4 shows these individual sliders 21 and 31. They are divided into top sliders 21 and bottom sliders 31 depending on whether they connect the curtain 10 to the top curtain rod 20 or bottom curtain rod 30.

The top sliders 21 are connected by a cord 22. Similarly, the bottom sliders 31 are connected by a cord 32.

FIG. 5 shows the row of top sliders 21 connected by the cord 22, said sliders comprising two top drive sliders 21a and 21b.

The top sliders 21 are regularly spaced apart and distributed into two groups: a first group and a second group intended to hook the first portion 10a and the second portion 10b of the curtain 10 respectively (not shown in FIG. 5).

The first top drive slider 21a is located at the end of the first group, in order to hook the first portion 10a of the curtain 10 by the corner located between its top side 12 and its distal lateral side 15a.

Similarly, the second top drive slider 21b is located at the end of the second group, in order to hook the second portion 10b of the curtain 10 by the corner located between its top side 12 and its distal lateral side 15b.

FIG. 6 shows the basic structure of the top sliders 21. Each slider 21 includes a block 211 provided with a peripheral slot cooperating with the rail of the top curtain rod 20 and ensuring the sliding of said slider, a hook 212 for hooking the curtain 10 for example via loops provided on its top side, and a ring 213 attached to the block 211 and supporting the hook 212.

The cord 22 passes through the hooks 212 of the sliders 21 and includes pairs of stoppers 221 placed on either side of each hook 212 to facilitate folding of the cord and maintain regular spacing between the waves of the curtain 10.

Indeed, each pair of stoppers blocks the slider associated with it on the cord and, due to the regular spacing between these pairs of stoppers, the cord length between two successive sliders always remains the same, whether the cord is taut or slack. This ensures regularity of the curtain waves in any position.

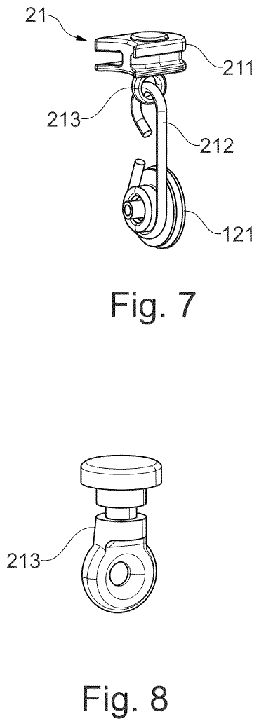

FIG. 7 shows an exemplary aspect wherein the top slider 21 is hooked to the curtain (not shown) by means of a button 121 which is attached to said curtain. Indeed, the button 121 includes an annular area inserted into the bottom loop of the hook 212. The top loop of the hook 212 is in turn inserted into the ring 213 and can pivot freely therein, which facilitates the movement of the curtain more generally. The ring 213 has a structure adapted for it to be rotatably mounted in the block 211, still with the aim of obtaining a smooth overall movement of the curtain.

FIG. 8 specifically illustrates the shape of the ring 213.

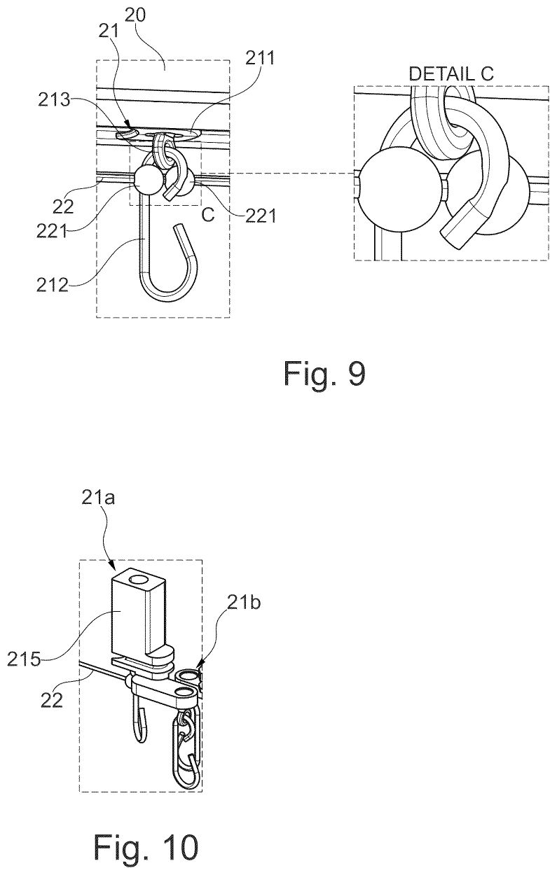

FIG. 9 shows a top slider 21 in position in the rail of the top rod 20.

Detail C shows the positioning of the stoppers 221 in relation to the hook 212. This positioning as well as their ball shape allow the stoppers 221 to limit the rotation of the hook 212 angularly, to thus avoid a complete rotation which would cause intertwining of the cord 22 for example.

This makes it possible to ensure a smooth movement of all of the sliders 21, and therefore of the curtain 10, driven by the top drive sliders 21a and 21b.

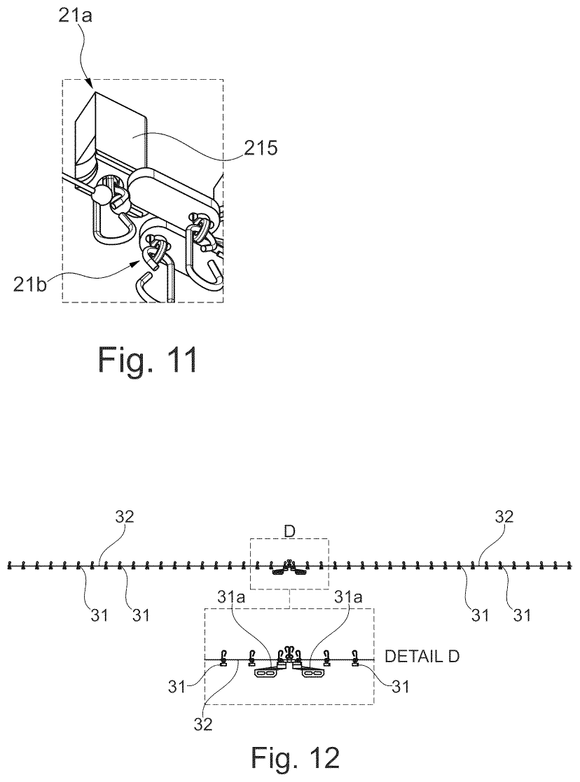

FIGS. 10 and 11 show the first top drive slider 21a, as well as a portion of the second top drive slider 21b, the two drive sliders joining when the curtain is closed.

Unlike the other top sliders 21, the top drive sliders 21a and 21b include a machined structure 215 extending from the block 211 to be coupled with the motorized drive system 50.

With reference to FIGS. 2a to 3b, the motorized drive system 50 is positioned laterally to the rear of the divider 100 and mainly comprises a motor, a mechanical shaft with a pulley and belt transmission system at both the upper portion and the lower portion of the curtain 10. The belts are reinforced and cooperate with a belt tensioner.

The rotational movement of the drive motor is transmitted synchronously to the drive sliders 21a, 21b, 31a and 31b, the latter then drive all the other sliders 21 and 31 one after the other.

The rotational speed of the motor is set so that the curtain slides smoothly. The closing and opening of the curtain 10 is actuated automatically by a simple “on-off” or progressive button.

Advantageously, the synchronized drive between the top and the bottom allows the lower portion of the curtain 10 to follow the movement to avoid problems when storing the curtain.

FIG. 12 shows the row of bottom sliders 31 connected by the cord 32, said sliders comprising two bottom drive sliders 31a and 31b.

The bottom sliders 31 are regularly spaced apart and distributed into two groups: a first group and a second group intended to hook the first portion 10a and the second portion 10b of the curtain 10 respectively (not shown in FIG. 12).

The first bottom drive slider 31a is located at the end of the first group, in order to hook the first portion 10a of the curtain 10 by the corner located between its bottom side 13 and its distal lateral side 15a.

Similarly, the second bottom drive slider 31b is located at the end of the second group, in order to hook the second portion 10b of the curtain 10 by the corner located between its bottom side 13 and its distal lateral side 15b.

Thus, the bottom drive sliders 31a and 31b are located opposite the top drive sliders 21a and 21b respectively.

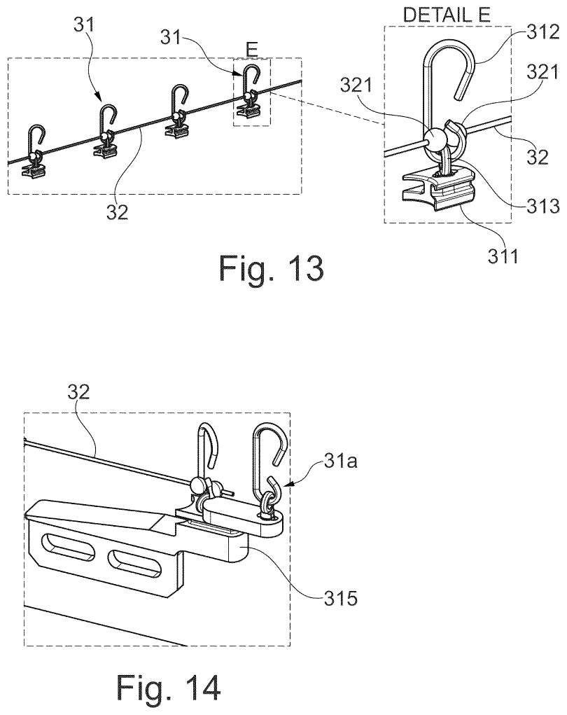

FIG. 13 shows the basic structure of the bottom sliders 31. This structure is identical to that of the top sliders 21 described hereinabove.

Indeed, each slider 31 includes a block 311 provided with a peripheral slot cooperating with the rail of the bottom curtain rod 30 and ensuring the sliding of said slider, a hook 312 for hooking the curtain 10, and a ring 313 attached to the block 311 and supporting the hook 312.

The cord 32 passes through the hooks 312 of the sliders 31 and includes pairs of stoppers 321 placed on either side of each hook 312 to facilitate folding of the cord and maintain regular spacing between the waves of the curtain 10.

FIG. 14 shows the first bottom drive slider 31a which, unlike the other bottom sliders 31, includes a machined structure 315 extending from the block 311 to be coupled with the motorized drive system in the same way as the top drive sliders. The second drive slider 31b is of course identical to the first, but disposed in an opposite direction as shown in Detail D of FIG. 12.

For safety reasons in the event of rapid decompression, the bottom curtain rod 30, in particular the bottom sliders 31, is configured to allow quick detachment of the curtain 10 from the bottom.

If the curtain does not unhook easily at the bottom in the event of rapid decompression, it can cause mechanical damage and thus injure the passenger.

The unhooking of the curtain 10 from the bottom is adjusted by the maximum load value supported by each hook 312. This value is for example 63N. Above this tensile load level, the hook 312 releases the curtain 10.

On the other hand, the upper portion of the curtain 10 is attached to the upper curtain rod 20 with higher unhooking loads at the hooks 212 so that the curtain is only detached from the bottom.

The divider 100 thus described is therefore designed to divide the areas between adjacent first-class passenger suites effectively. This divider is full-height, covering the entire usable height of the cabin, thus ensuring complete division between adjacent suites. It is equipped with a motorized curtain that can be opened or closed automatically, offering flexibility of use and easy control for passengers. The curtain is designed with regular waves for a visually appealing appearance and made of opaque textile material to ensure visual privacy between suites. Furthermore, the system for storing the curtain when it is open is optimized to minimize the size, thus improving the space available in the cabin. Finally, safety measures are integrated to allow quick detachment of the curtain in the event of decompression, ensuring passenger safety. In summary, the present disclosure provides a sophisticated solution for improving the comfort, privacy and safety of first-class passengers.

What is claimed is:

1. An aircraft cabin divider, dividing two adjacent private passenger areas in the same class, including a curtain hung by its top side from a top curtain rod, said divider having an open position and a closed position, and characterized in that it is full-height, thus covering a height up to the ceiling of the aircraft cabin wherein it is installed, and in that it is hooked by its bottom side to a bottom curtain rod opposite the top curtain rod.

2. The divider according to claim 1, wherein the curtain includes a first portion and a second portion that are separate, said portions being configured so that their movements are synchronized and joining at a central closing line when said divider is in the closed position.

3. The divider according to claim 1, wherein each curtain rod includes a slide rail and sliders physically connecting the curtain to the slide rail, each slider including a sliding block on the rail and a hook for hooking the curtain.

4. The divider according to claim 3, wherein the sliders of each curtain rod are connected by a cord including stoppers placed at regular intervals, to maintain regular waves of the curtain.

5. The divider according to claim 1, further including a motorized drive system for automatically actuating the opening and closing movements of said divider, said system being coupled in a synchronized manner with both an upper portion and a lower portion of the curtain.

6. The divider according to claim 5, wherein at least one proximal lateral side of the curtain is coupled with the motorized drive system by means of two linking members: one in the upper portion and the other in the lower portion.

7. The divider according to claim 1, wherein the lower curtain rod is configured to allow the curtain to be detached from the bottom in the event of rapid decompression, when said divider is in the closed position in an aircraft cabin.

8. The divider according to claim 7, wherein the bottom curtain rod includes bottom sliders to attach the bottom side of the curtain, and each bottom slider includes a hook which is detached from the curtain beyond a maximum tensile load, to release the curtain in the event of rapid decompression of the cabin.

9. The divider according to claim 1, wherein the curtain is fully concealed in a compact storage space when said divider is in the open position.

10. An aircraft cabin comprising two adjacent private suites, and characterized in that it comprises a divider according to claim 1 placed between said suites.
